(19) United States
(12) Patent Application Publication
(10) Pub. No.: US 2021/0364843 A1
(43) Pub. Date: Nov. 25, 2021

(54) LIQUID CRYSTAL DISPLAY PANEL AND DISPLAY DEVICE

(71) Applicant: TCL China Star Optoelectronics Technology Co., Ltd., Shenzhen (CN)

(72) Inventor: Xuetao Cai, Shenzhen (CN)

(21) Appl. No.: 16/617,300

(22) PCT Filed: Apr. 22, 2019
(86) PCT No.: PCT/CN2019/083686

§ 371 Date: Nov. 26, 2019

(30) Foreign Application Priority Data
Apr. 9, 2019 (CN) 201910281697.7

(51) Int. Cl. G02F 1/1343; G02F 1/1335; G02F 1/1362; G02F 1/1368

(52) U.S. Cl. CPC G02F 1/13439; G02F 1/133514; G02F 1/134309; G02F 1/136286; G02F 2201/122; G02F 1/13624; G02F 2201/121; G02F 2201/123; G02F 1/1368

(57) ABSTRACT

A liquid crystal display panel and a display device, a portion of each of DBS common electrode lines located at a periphery of each of pixel units is electrically connected to a common electrode layer of a color filter substrate, and a portion of each of DBS common electrode lines and an array substrate located inside a pixel unit are disconnected, thereby a voltage difference between the common electrode layer of the DBS common electrode layer and the common electrode layer of the color filter substrate is reduced. The present application can avoid burns caused by conductive particles, reduce the particles sensation of the liquid crystal display panel and improve the yield.

### BACKGROUND OF INVENTION

### Field of Invention

The present invention relates to the field of display technologies, and in particular, to a liquid crystal display panel and a display device.

### Description of Prior Art

FIG. 1 is a schematic top plan diagram of a current array substrate 1′ designed using a black matrix less (DBS). The current liquid crystal display panel generally includes an array substrate 1′, a color film substrate disposed corresponding to the array substrate 1′ (not shown) and a liquid crystal layer (not shown) disposed between the array substrate 1′ and the color filter substrate. The array substrate 1′ includes a plurality of scan lines 12 and a plurality of data lines 13, and the gate lines 12 are disposed across the data lines 13 to define a plurality of pixel units. A pixel electrode is disposed in the pixel unit, and the array substrate adopts a 3T pixel unit structure as shown in FIG. 4. DBS common electrode lines are disposed above the data lines 13. The DBS common electrode lines are electrically connected to common electrode lines A-com on the array substrate 1′ through a via hole 16 of a common thin film transistor. The via hole 16 is bridged by indium tin oxide (ITO). A potential of the DBS common electrode lines and a potential of a common electrode layer CF-com of the color filter substrate are the same. Therefore, liquid crystal molecules can be kept in an undeflected state and the purpose of shading is achieved. Further, a black matrix (BM) corresponding to the data lines 13 in the liquid crystal display panel can be replaced.

However, when the liquid crystal display panel is optically phase-matched, a voltage of the common electrode lines A-com of the array substrate 1′ may not be equal to a voltage of the common electrode layer CF-com of the color filter substrate, thereby an electric field is formed between the DBS common electrode line and the common electrode layer CF-com of the color filter substrate, and conductive particles between the array substrate 1′ and the color filter substrate will burn the top and bottom plates of the liquid crystal display panel and reduce the yield.

Therefore, it is necessary to provide a new liquid crystal display panel and a liquid crystal display device to solve the above technical problems.

### Technical Problems

The present application provides a liquid crystal display panel and a display device, which solves the problem that when the liquid crystal display panel is optically phase-matched, a voltage of the common electrode lines A-com of the array substrate 1′ may not be equal to a voltage of the common electrode layer CF-com of the color filter substrate, thereby an electric field is formed between the DBS common electrode line and the common electrode layer CF-com of the color filter substrate, and conductive particles between the array substrate 1′ and the color filter substrate will burn the top and bottom plates of the liquid crystal display panel and reduce the yield.

### SUMMARY OF INVENTION

In order to solve the above problems, the technical solution provided by the present disclosure is as follows:

The present application provides a liquid crystal display panel including an array substrate, a color filter substrate disposed opposite to the array substrate, and a liquid crystal layer disposed between the array substrate and the color filter substrate;

wherein the array substrate comprises:

a plurality of scan lines;

a plurality of data lines disposed across the plurality of scan lines;

a plurality of pixel units defined by the plurality of the scan lines and the plurality of the data lines, a plurality of pixel electrodes disposed in the plurality of pixel units, and the pixel electrodes are square-shaped pattern electrodes;

a plurality of black matrix less (DBS) common electrode lines disposed above the plurality of data lines, wherein a width of each of the DBS common electrode lines is greater than a width of each of the data lines;

wherein a portion of each of the DBS common electrode lines located at a periphery of each of the pixel units is electrically connected to a common electrode layer of the color filter substrate, and a portion of each of the DBS common electrode lines located inside each of the pixel units is disconnected from common electrode lines of the array substrate.

In the liquid crystal display panel according to the present application, wherein a material of the DBS common electrode lines is indium tin oxide.

In the liquid crystal display panel according to the present application, wherein a gold ball is disposed between the portion of each of the DBS common electrode lines located at a periphery of each of the pixel units and the common electrode layer of the color filter substrate to achieve an electrical connection therebetween.

In the liquid crystal display panel according to the present application, wherein the pixel units each are divided into a main pixel region and a sub-pixel region.

In the liquid crystal display panel according to the present application, wherein the main pixel region comprises a main thin film transistor and a main pixel electrode, a gate of the main thin film transistor is connected to the scan line, a source of the main thin film transistor is connected to the data line, and a drain of the main thin film transistor is connected to the main pixel electrode.

In the liquid crystal display panel according to the present application, wherein the sub-pixel region comprises an auxiliary thin film transistor, a shared thin film transistor, and an auxiliary pixel electrode;

wherein a gate of the auxiliary thin film transistor is connected to the scan line, a source of the auxiliary thin film transistor is connected to the data line, a drain of the auxiliary thin film transistor is connected to the auxiliary pixel electrode and a source of the shared thin film transistor, a gate of the shared thin film transistor is connected to the scan line, and a drain of the shared thin film transistor is connected to the common electrode line.

In the liquid crystal display panel according to the present application, wherein the array substrate comprises a first metal layer and a second metal layer, wherein the common electrode lines of the array substrate are located in the first metal layer, and the data lines are located in the second metal layer.

The present application further provides a liquid crystal display panel comprising an array substrate, a color filter substrate disposed opposite to the array substrate, and a liquid crystal layer disposed between the array substrate and the color filter substrate;

wherein the array substrate comprises:

a plurality of scan lines;

a plurality of data lines disposed across the plurality of scan lines;

a plurality of pixel units defined by the plurality of the scan lines and the plurality of the data lines, a plurality of pixel electrodes disposed in the plurality of pixel units; and

a plurality of black matrix less (DBS) common electrode lines disposed above the plurality of data lines;

wherein a portion of each of the DBS common electrode lines located at a periphery of each of the pixel units is electrically connected to a common electrode layer of the color filter substrate, and a portion of each of the DBS common electrode lines located inside each of the pixel units is disconnected from common electrode lines of the array substrate.

In the liquid crystal display panel according to the present application, wherein a width of each of the DBS common electrode lines is greater than a width of each of the data lines.

In the liquid crystal display panel according to the present application, wherein a material of the DBS common electrode lines is indium tin oxide.

In the liquid crystal display panel according to the present application, wherein a gold ball is disposed between the portion of each of the DBS common electrode lines located at a periphery of each of the pixel units and the common electrode layer of the color filter substrate to achieve an electrical connection therebetween.

In the liquid crystal display panel according to the present application, wherein the pixel units each are divided into a main pixel region and a sub-pixel region.

In the liquid crystal display panel according to the present application, wherein the main pixel region comprises a main thin film transistor and a main pixel electrode, a gate of the main thin film transistor is connected to the scan line, a source of the main thin film transistor is connected to the data line, and a drain of the main thin film transistor is connected to the main pixel electrode.

In the liquid crystal display panel according to the present application, wherein the sub-pixel region comprises an auxiliary thin film transistor, a shared thin film transistor, and an auxiliary pixel electrode,

auxiliary thin film transistor is connected to the data line, a drain of the auxiliary thin film transistor is connected to the auxiliary pixel electrode and a source of the shared thin film transistor, a gate of the shared thin film transistor is connected to the scan line, and a drain of the shared thin film transistor is connected to the common electrode line.

In the liquid crystal display panel according to the present application, wherein the array substrate comprises a first metal layer and a second metal layer, wherein the common electrode lines of the array substrate are located in the first metal layer, and the data lines are located in the second metal layer.

In the liquid crystal display panel according to the present application, wherein the pixel electrodes are square-shaped pattern electrodes.

The present application provides a display device including the above liquid crystal display panel.

Beneficial Effects

The beneficial effects of the application including: in the liquid crystal display panel and the display device provided by the present application, a portion of each of the DBS common electrode lines located at the periphery of each of the pixel units is electrically connected to the common electrode layer of the color filter substrate, and a portion of each of the DBS common electrode lines and the array substrate located inside the pixel unit are disconnected. The present application can reduce the voltage difference between the common electrode layer of the DBS common electrode layer and the common electrode layer of the color filter substrate, thereby avoid burns caused by conductive particles without changing the overall design structure of the pixel units when the liquid crystal display panel performs optical phase-matching. It reduces the particles sensation of the liquid crystal display panel and improves the yield.

### BRIEF DESCRIPTION OF DRAWINGS

In order to describe clearly the embodiment in the present disclosure or the prior art, the following will introduce the drawings for the embodiment shortly. Obviously, the following description is only a few embodiments, for the common technical personnel in the field it is easy to acquire some other drawings without creative work.

FIG. 1 is a schematic top plan diagram of an array substrate in prior art;

FIG. 2 is a cross-sectional structural diagram of a liquid crystal display panel according to an embodiment of the present disclosure;

FIG. 3 is a schematic top plan diagram of an array substrate according to an embodiment of the present disclosure;

FIG. 4 is a schematic circuit diagram of a pixel unit of a liquid crystal display panel according to an embodiment of the present disclosure;

FIG. 5 is a schematic structural diagram of a display device according to an embodiment of the present disclosure.

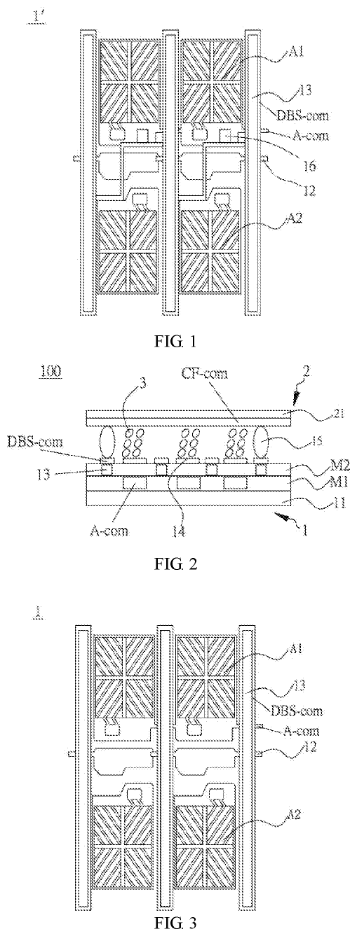

### DETAILED DESCRIPTION OF PREFERRED EMBODIMENTS

Description of following embodiment, with reference to accompanying drawings, is used to exemplify specific embodiments which may be carried out in the present disclosure. Directional terms mentioned in the present disclosure, such as “top”, “bottom”, “front”, “back”, “left”, “right”, “inside”, “outside”, “side”, etc., are only used with reference to orientation of the accompanying drawings. Therefore, the directional terms are intended to illustrate, but not to limit, the present disclosure. In the drawings, components having similar structures are denoted by same numerals.

The present application provides a liquid crystal display panel and a display device, which solves the problem that when the liquid crystal display panel is optically phase-matched, a voltage of the common electrode lines A-com of the array substrate 1′ may not be equal to a voltage of the common electrode layer CF-com of the color filter substrate, thereby an electric field is formed between the DBS common electrode line and the common electrode layer CF-com of the color filter substrate, and conductive particles between the array substrate 1′ and the color filter substrate will burn the top and bottom plates of the liquid crystal display panel and reduce the yield.

As shown in FIG. 2 and FIG. 3, the liquid crystal display panel 100 including an array substrate 1, a color filter substrate 2 disposed opposite to the array substrate 1, and a liquid crystal layer 3 disposed between the array substrate 1 and the color filter substrate 2.

The array substrate 1 includes a first glass substrate 11 on which a first metal layer M1 and a second metal layer M2 are disposed. The first metal layer M1 includes a plurality of scan lines 12, the second metal layer M2 includes a plurality of data lines 13 and sources and drains (not shown) constituting thin film transistors (TFT). A plurality of the scan lines 12 are disposed across the plurality of the data lines 13 to define a plurality of pixel units 14, a plurality of pixel units 14 are provided with pixel electrodes therein. A plurality of black matrix less (DB S) common electrode lines DBS-com are disposed above the plurality of data lines 13.

Specifically, the DBS common electrode lines DBS-com are disposed corresponding to the plurality of the data lines 13, wherein a width of each of the DBS common electrode lines is greater than a width of each of the data lines. An electric field formed by the DBS common electrode lines DBS-com can keep liquid crystal molecules in the liquid crystal layer 3 to be in an undeflected state and the purpose of shading is achieved. Further, a black matrix (BM) corresponding to the data lines 13 in the liquid crystal display panel can be replaced. Further, the material of each of the DBS common electrode lines DBS-com is indium tin oxide (ITO).

Specifically, each of the pixel units 14 includes a red pixel unit R, a green pixel unit and a blue pixel unit B that are repeatedly arranged in sequence. The DBS common electrode lines DBS-com are respectively disposed between the red pixel unit R and the green pixel unit between the green pixel unit G and the blue pixel unit B or between the blue pixel unit B and the red pixel unit R.

The color filter substrate 2 includes a second glass substrate 21 and a common electrode layer CF-com disposed on the second glass substrate 21. A gold ball 15 is disposed between the portion of each of the DBS common electrode lines DB S-com located at a periphery of each of the pixel units and the common electrode layer CF-com of the color filter substrate 2 to achieve an electrical connection therebetween. A portion of each of the DBS common electrode lines DBS-com located inside the pixel unit 14 and the common electrode lines DBS-com of the array substrate 1 are not provided with a via hole, so that the DBS common electrode lines DBS-com and the common electrode lines DBS-com of the array substrate 1 are disconnected. Of course, the medium for electrically connecting the DBS common electrode lines DBS-com and the common electrode layer CF-com of the color filter substrate 2 should not be limited to golden ball 15, but also can be other conductive medium, the embodiment of the present disclosure should not be limited thereto.

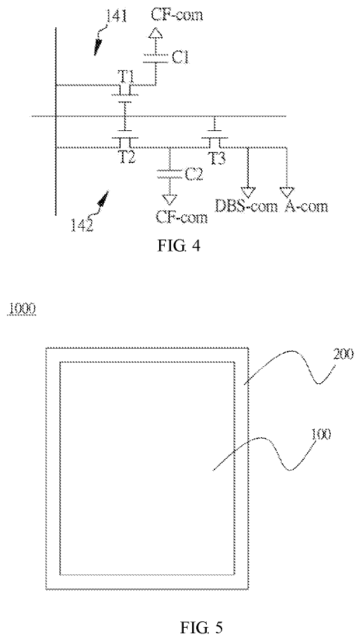

As shown in FIG. 4, each of the pixel units 14 is divided into a main pixel region 141 and a sub-pixel region 142. The main pixel region 141 includes a main thin film transistor T1 and a main pixel electrode A1. A gate of the main thin film transistor T1 is connected to the corresponding scan line 12, a source of the main thin film transistor T1 is connected to the corresponding data line 13, a drain of the main thin film transistor T1 is connected to the main pixel electrode A1. The main pixel electrode A1 also forms a first storage capacitor C1 with the common electrode layer CF-com on the color filter substrate 2.

The sub-pixel region 142 includes an auxiliary thin film transistor T2 and a shared thin film transistor T3 and an auxiliary pixel electrode A2. A gate of the thin film transistor T2 is connected to the corresponding scan line 12, a source of the thin film transistor T2 is connected to a data line 13 corresponding to the pixel unit 14, a drain of the thin film transistor T2 is connected to the auxiliary pixel electrode A2, a gate of the shared thin film transistor T3 is connected to the corresponding scan line 12, a source of the shared thin film transistor T3 is connected to a drain of the auxiliary thin film transistor T2, a source of the shared thin film transistor T3 is connected to the common electrode A-com of the array substrate 11. A second storage capacitor C2 is formed between the auxiliary pixel electrode A2 and the common electrode layer CF-com of the color filter substrate 2. Specifically, the capacitance values of the first storage capacitor C1 and the second storage capacitor C2 are equal.

That is, the main pixel region 141 is driven by the main thin film transistor T1. The sub-pixel region 142 is driven by the auxiliary thin film transistor T2 and the shared thin film transistor T3 for pulling down the voltage of the auxiliary pixel region 142.

Specifically, referring to FIG. 3, the main pixel electrode A1 and the auxiliary pixel electrode A2 are both square-shaped pattern electrodes, and the materials of the main pixel electrode A1 and the auxiliary pixel electrode A2 are both ITO.

Therefore, compared with the prior art, the circuit structure of the pixel unit 14 of the liquid crystal display panel 100 provided by the embodiments of the present disclosure also adopts a 3T pixel structure.

That is, the liquid crystal display panel 100 of the embodiments of the present application remove the via hole 16 on the shared thin film transistor T3 by not connecting the partial DBS common electrode lines DB S-com located inside the pixel unit 14 with the common electrode lines A-com of the array substrate 1 without changing the overall design architecture of the pixel unit. Therefore, when optical phase matching is performed, the voltage of the DBS common electrode lines DBS-com is not equal to the voltage of the common electrode lines A-com of the array substrate 1. Meanwhile, a portion of each of the DBS common electrode lines DBS-com located at the periphery of each of the pixel units 14 is electrically connected to the common electrode layer CF-com of the color filter substrate 2, and thus the voltage each of the DBS common electrode lines DBS-com is equal to the voltage of the common electrode layer CF-com of the color filter substrate 2. That is, the pressure difference between the DBS common electrode lines DBS-com and the common electrode layer CF-com of the color filter substrate 2 is zero. If conductive particles or the like are exited between the array substrate 1 and the color filter substrate 2, the conductive particles will not be driven by voltage. Therefore, the present application can effectively avoid the risk of burns on the top and bottom plates of the liquid crystal display panel 100 caused by the electrification of the conductive particles, thereby reducing the particles sensation of the liquid crystal display panel 100 and improving the yield.

As shown in FIG. 5, an embodiment of the present disclosure further provides a display device 1000, where the display device is a liquid crystal display device. The display device includes the liquid crystal display panel 100 described above and a backlight module 200 that provides a backlight for the liquid crystal display panel 100. The display device 1000 can be any product or component having a display function, such as a mobile phone, a tablet computer, a television, a digital camera, and the like. The display device 1000 has the technical effects of the liquid crystal display panel 100 and will not be further described herein.

The beneficial effects of the application including: in the liquid crystal display panel and the display device provided by the present application, a portion of each of the DBS common electrode lines located at the periphery of each of the pixel units is electrically connected to the common electrode layer of the color filter substrate, and a portion of each of the DBS common electrode lines and the array substrate located inside the pixel unit are disconnected. The present application can reduce the voltage difference between the common electrode layer of the DBS common electrode layer and the common electrode layer of the color filter substrate, thereby avoid burns caused by conductive particles without changing the overall design structure of the pixel units when the liquid crystal display panel performs optical phase-matching. It reduces the particles sensation of the liquid crystal display panel and improves the yield.

As is understood by persons skilled in the art, the foregoing preferred embodiments of the present disclosure are illustrative rather than limiting of the present disclosure. It is intended that they cover various modifications and that similar arrangements be included in the spirit and scope of the present disclosure, the scope of which should be accorded the broadest interpretation so as to encompass all such modifications and similar structures.

What is claimed is:

1. A liquid crystal display panel comprising an array substrate, a color filter substrate disposed opposite to the array substrate, and a liquid crystal layer disposed between the array substrate and the color filter substrate;
wherein the array substrate comprises:
a plurality of scan lines;
a plurality of data lines disposed across the plurality of scan lines;
a plurality of pixel units defined by the plurality of the scan lines and the plurality of the data lines, a plurality of pixel electrodes disposed in the plurality of pixel units, and the pixel electrodes are square-shaped pattern electrodes;
a plurality of black matrix less (DBS) common electrode lines disposed above the plurality of data lines, wherein a width of each of the DBS common electrode lines is greater than a width of each of the data lines;
wherein a portion of each of the DBS common electrode lines located at a periphery of each of the pixel units is electrically connected to a common electrode layer of the color filter substrate, and a portion of each of the DBS common electrode lines located inside each of the pixel units is disconnected from common electrode lines of the array substrate.

2. The liquid crystal display panel according to claim 1, wherein a material of the DBS common electrode lines is indium tin oxide.

3. The liquid crystal display panel according to claim 1, wherein a gold ball is disposed between the portion of each of the DBS common electrode lines located at a periphery of each of the pixel units and the common electrode layer of the color filter substrate to achieve an electrical connection therebetween.

4. The liquid crystal display panel according to claim 1, wherein the pixel units each are divided into a main pixel region and a sub-pixel region.

5. The liquid crystal display panel according to claim 4, wherein the main pixel region comprises a main thin film transistor and a main pixel electrode, a gate of the main thin film transistor is connected to the scan line, a source of the main thin film transistor is connected to the data line, and a drain of the main thin film transistor is connected to the main pixel electrode.

6. The liquid crystal display panel according to claim 4, wherein the sub-pixel region comprises an auxiliary thin film transistor, a shared thin film transistor, and an auxiliary pixel electrode;
wherein a gate of the auxiliary thin film transistor is connected to the scan line, a source of the auxiliary thin film transistor is connected to the data line, a drain of the auxiliary thin film transistor is connected to the auxiliary pixel electrode and a source of the shared thin film transistor, a gate of the shared thin film transistor is connected to the scan line, and a drain of the shared thin film transistor is connected to the common electrode line.

7. The liquid crystal display panel according to claim 1, wherein the array substrate comprises a first metal layer and a second metal layer, wherein the common electrode lines of the array substrate are located in the first metal layer, and the data lines are located in the second metal layer.

8. A liquid crystal display panel comprising an array substrate, a color filter substrate disposed opposite to the array substrate, and a liquid crystal layer disposed between the array substrate and the color filter substrate;
wherein the array substrate comprises:
a plurality of scan lines;
a plurality of data lines disposed across the plurality of scan lines;
a plurality of pixel units defined by the plurality of the scan lines and the plurality of the data lines, a plurality of pixel electrodes disposed in the plurality of pixel units; and
a plurality of black matrix less (DBS) common electrode lines disposed above the plurality of data lines;
wherein a portion of each of the DBS common electrode lines located at a periphery of each of the pixel units is electrically connected to a common electrode layer of the color filter substrate, and a portion of each of the DBS common electrode lines located inside each of the pixel units is disconnected from common electrode lines of the array substrate.

9. The liquid crystal display panel according to claim 8, wherein a width of each of the DBS common electrode lines is greater than a width of each of the data lines.

10. The liquid crystal display panel according to claim 9, wherein a material of the DBS common electrode lines is indium tin oxide.

11. The liquid crystal display panel according to claim 10, wherein a gold ball is disposed between the portion of each of the DBS common electrode lines located at a periphery of each of the pixel units and the common electrode layer of the color filter substrate to achieve an electrical connection therebetween.

12. The liquid crystal display panel according to claim 8, wherein the pixel units each are divided into a main pixel region and a sub-pixel region.

13. The liquid crystal display panel according to claim 12, wherein the main pixel region comprises a main thin film transistor and a main pixel electrode, a gate of the main thin film transistor is connected to the scan line, a source of the main thin film transistor is connected to the data line, and a drain of the main thin film transistor is connected to the main pixel electrode.

14. The liquid crystal display panel according to claim 12, wherein the sub-pixel region comprises an auxiliary thin film transistor, a shared thin film transistor, and an auxiliary pixel electrode,
auxiliary thin film transistor is connected to the data line, a drain of the auxiliary thin film transistor is connected to the auxiliary pixel electrode and a source of the shared thin film transistor, a gate of the shared thin film transistor is connected to the scan line, and a drain of the shared thin film transistor is connected to the common electrode line.

15. The liquid crystal display panel according to claim 8, wherein the array substrate comprises a first metal layer and a second metal layer, wherein the common electrode lines of the array substrate are located in the first metal layer, and the data lines are located in the second metal layer.

16. The liquid crystal display panel according to claim 8, wherein the pixel electrodes are square-shaped pattern electrodes.

17. A display device comprising the liquid crystal display panel of claim 8.
